(19) United States
(12) Patent Application Publication
(10) Pub. No.: US 2021/0325735 A1
(43) Pub. Date: Oct. 21, 2021

(54) DISPLAY DEVICE

(71) Applicant: InnoLux Corporation, Miao-Li County (TW)

(72) Inventors: Chien-Chih LIAO, Miao-Li County (TW); Hsing-Yuan HSU, Miao-Li County (TW); Po-Yang CHEN, Miao-Li County (TW); I-An YAO, Miao-Li County (TW)

(21) Appl. No.: 17/206,158

(22) Filed: Mar. 19, 2021

(30) Foreign Application Priority Data
Apr. 16, 2020 (CN) 202010301754.6

(51) Int. Cl. G02F 1/13357; F21V 8/00; G06K 9/00

(52) U.S. Cl. CPC G02F 1/133617; G06K 9/0004; G02B 6/005; G02F 1/133602

(57) ABSTRACT

The present disclosure provides a display device including a liquid crystal panel, a light source, and an optical sensor. The light source includes two light emitting elements for emitting two lights with different wavelengths to the liquid crystal panel. The optical sensor is for sensing one of the lights, and the light source is disposed between the liquid crystal panel and the optical sensor.

### CROSS REFERENCE TO RELATED APPLICATION

This application claims the benefit of Chinese Patent Application Serial No. 202010301754.6, filed Apr. 16, 2020, and the entire contents of which are incorporated herein by reference.

### BACKGROUND OF THE DISCLOSURE

### 1. Field of the Disclosure

The present disclosure relates to a display device, and more particularly to a display device with fingerprint identification function.

### 2. Description of the Prior Art

With the advance of technology, various electronic devices have been used in everyone's daily life. Some electronic devices store private data, and thus, fingerprint identification technology has been developed for security. In recent years, researchers in this field have dedicated to integrate fingerprint sensing function and display function in one electronic device, but there are still many problems to be solved.

### SUMMARY OF THE DISCLOSURE

An embodiment of the present disclosure provides a display device including a liquid crystal panel, a light source, and an optical sensor. The light source includes two light emitting elements for emitting two lights with different wavelengths to the liquid crystal panel. The optical sensor is for sensing one of the lights, and the light source is disposed between the liquid crystal panel and the optical sensor.

Another embodiment of the present disclosure provides a display device including a liquid crystal panel, a light source, a wavelength conversion layer, and an optical sensor. The light source includes a light emitting element for emitting a light to the liquid crystal panel. The wavelength conversion layer is disposed on the light emitting element, and the wavelength conversion layer converts a part of the light into another light, wherein a wavelength of the light is different from a wavelength of the another light. The optical sensor is for sensing one of the light and the another light. The light source is disposed between the liquid crystal panel and the optical sensor.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a cross-sectional view of a display device according to a first embodiment of the present disclosure.

FIG. 2 schematically illustrates a cross-sectional view of a display device according to a second embodiment of the present disclosure.

FIG. 3 schematically illustrates a cross-sectional view of a display device according to a third embodiment of the present disclosure.

FIG. 4 schematically illustrates a cross-sectional view of a display device according to a variant embodiment of the third embodiment of the present disclosure.

FIG. 5 schematically illustrates a cross-sectional view of a display device according to another variant embodiment of the third embodiment of the present disclosure.

FIG. 6 schematically illustrates a cross-sectional view of a display device according to a fourth embodiment of the present disclosure.

FIG. 7 schematically illustrates a cross-sectional view of a display device according to a variant embodiment of the fourth embodiment of the present disclosure.

### DETAILED DESCRIPTION

The contents of the present disclosure will be described in detail with reference to specific embodiments and drawings. It is noted that, for purposes of illustrative clarity and being easily understood by readers, the following drawings may be simplified schematic diagrams, and elements therein may not be drawn to scale. The numbers and dimensions of the elements in the drawings are just illustrative, and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function. In the following description and claims, the terms “comprise”, “include” and “have” are open-ended fashion, so they should be interpreted as “including but not limited to . . . ”.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure. It should be understood that the elements in the drawings may be disposed in any kind of formation known by one skilled in the related art to describe the elements in a certain way. Furthermore, when one element or one layer is called “on” another element or another layer, or called “connected to” another element or another layer, it may be understood that the one element or the one layer is “directly on” the another element or the another layer, or “directly connected to” the another element or the another layer, or another element or another layer may be disposed between the one element and the another element or between the one layer and the another layer (indirectly). On the contrary, when the one element or the one layer is called “directly on” or “directly connected to” the another element or the another layer, it may be understood that there is no other elements or layers sandwiched between the one element and the another element or between the one layer and the another layer.

When ordinal numbers, such as “first” and “second”, used in the specification and claims are used to modify elements in the claims, they do not mean and represent that the claimed elements have any previous ordinal numbers, nor do they represent the order of a claimed element and another claimed element, or the order of manufacturing methods. These ordinal numbers are just used to distinguish a claimed element with a certain name from another claimed element with the same name.

In this document, the terms “about”, “substantially” and “approximately” usually mean within 10%, 5%, 3%, 2%, 1% or 0.5% of a given value or range. The quantity given herein is an approximate quantity, that is, without specifying “about”, “substantially” and “approximately”, the meanings of “about”, “substantially” and “approximately” may still be implied. In addition, the term “range from a first value to a second value” and the term “between a first value and a second value” means that the range includes the first value, the second value and other values between them.

It should be understood that according to the following embodiments, features of different embodiments may be replaced, recombined or mixed to constitute other embodiments without departing from the spirit of the present disclosure.

The display device disclosed in the present disclosure may include an antenna device, a light emitting device, a sensing device, or a tiled device, but is not limited thereto. The display device may include a bendable or flexible display device. The antenna device may be, for example, a liquid crystal antenna, but is not limited to this. The tiled device may be, for example, a display tiled device or an antenna tiled device, but is not limited to this. It should be noted that the display device may be any combination of the foregoing, but is not limited thereto.

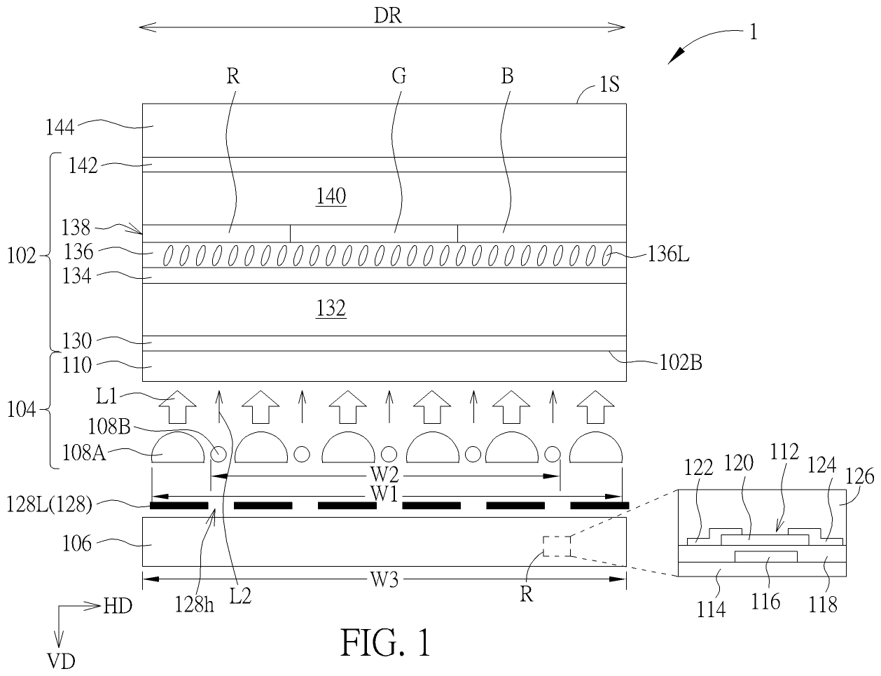

FIG. 1 schematically illustrates a cross-sectional view of a display device according to a first embodiment of the present disclosure. As shown in FIG. 1, the display device 1 may include a liquid crystal panel 102, a light source 104 and an optical sensor 106, wherein the light source 104 may be disposed between the liquid crystal panel 102 and the optical sensor 106. In an embodiment, the light source 104 may include at least two light emitting elements (e.g., one light emitting element 108A and one light emitting element 108B) generating two lights (e.g., light L1 and light L2) with different wavelengths and emitting the two lights to the liquid crystal panel 102, and the optical sensor 106 may be for sensing one of the two lights (e.g., light L1 or light L2). For example, the light emitting element 108A may generate light L1, the light emitting element 108B may generate light L2, and the wavelength of the light L1 may be different from the wavelength of the light L2. The wavelength or wavelength range of the light L2 may be, for example, different from (e.g. greater than) the wavelength or wavelength range of the light L1, and the optical sensor 106 may sense the light L2, but is not limited thereto. In an embodiment, the light L1 may be visible light, and the light L2 may be invisible light. In some embodiments, the wavelength may be the maximum, the minimum, or the middle wavelength in the wavelength range of the light L1 and the light L2, but not limited thereto. For example, the maximum wavelength of the light L1 may be different from the maximum wavelength of the light L2. In this case, the visible light L1 may be used as a backlight of the liquid crystal panel 102, so that the display device 1 may display images, and the optical sensor 106 may detect the invisible light L2. Therefore, when a finger is placed on the display surface 1S of the display device 1, the light L2 may be reflected by the finger, such that the optical sensor 106 may detect the reflected light L2 by the finger, thereby obtaining a fingerprint image of the finger. It should be noted that since the optical sensor 106 may detect the light L2 with the specific wavelength, and may not detect the light L1, the optical sensor 106 under the light source 104 may perform fingerprint identification without being affected by the light L1. When the light L2 is invisible, the light L1 for displaying the images also is not affected by the light L2, so that the display device 1 may for example perform the display function and the fingerprint identification function at the same time, but not limited to this. The invisible light may be, for example, an infrared light, which may include, for example, near infrared light, mid infrared light, far infrared light or a combination of at least two of the above, and in this case, the optical sensor 106 may be an optical sensor of infrared light, but is not limited thereto. The type of the optical sensor 106 may be adjusted according to the wavelength or wavelength range of the light L2 which is to be detected. In some embodiments, at least one of the light emitting element 108A and the light emitting element 108B may simultaneously generate the light L1 and the light L2 with different wavelengths or different wavelength ranges. In some embodiments, the number of the light emitting element 108A and/or the number of the light emitting element 108B in the light source 104 may be, for example, plural, depending on the requirements of the display device 1 (e.g., detection range).

The light emitting element 108A and the light emitting element 108B may for example include inorganic light emitting diode (LED), organic light emitting diode (OLED), mini light emitting diode (mini LED), micro light emitting diode (micro LED), quantum dot LED (may include QLED, QDLED), nano wire LED or bar type LED. In some embodiments, the light emitting element 108A and the light emitting element 108B may also include a fluorescent material, phosphor, or other suitable materials, or a combination of the mentioned above, but not limited thereto.

In the embodiment shown in FIG. 1, the light source 104 may be a direct-type light source. For example, the light source 104 may include a plurality of light emitting elements 108A disposed under the liquid crystal panel 102. The light emitting region of the light emitting elements 108A may be, for example, substantially greater than or the same as the display region DR of the liquid crystal panel 102 for displaying the images. For example, a distribution width W1 of the light emitting elements 108A in a horizontal direction HD parallel to the display surface 1S may be substantially the same as the width of the display region DR in the horizontal direction HD, and the light source 104 may be used as the backlight of the liquid crystal panel 102, but is not limited thereto. In order to clearly illustrate the structure of the display device 1, FIG. 1 illustrates the display region DR of the liquid crystal panel 102, but does not show a non-display region of the liquid crystal panel 102 (for example, a peripheral region where peripheral circuits are disposed therein). Accordingly, the width of the display region DR shown in FIG. 1 may be substantially the same as the distribution width W1 of the corresponding light emitting elements 108A, but the present disclosure is not limited thereto. In some embodiments, the light source 104 may include a plurality of light emitting elements 108B disposed under the liquid crystal panel 102. The fingerprint identification region of the display device 1 may be adjusted by changing a distribution width W2 of the light emitting elements 108B and a distribution width W3 of the optical sensor 106. For example, in the horizontal direction HD, the distribution width W2 of the light emitting elements 108B and/or the distribution width W3 of the optical sensor 106 may be 5% to 100% of the width of the display region DR, such as 20%, 40%, 60%, or 80% of the width of the display region DR. In the horizontal direction HD, when the distribution width W3 of the optical sensor 106 is 100% of the width of the display region DR while the distribution width W1 of the light emitting elements 108B is greater than or equal to the width of the display region DR, the region where the display device 1 is able to identify fingerprints may be the same as the display region DR. In other words, the display device 1 may be called as a full-screen fingerprint identification display device, but is not limited thereto.

In some embodiments, the light source 104 may be, for example, a direct-type backlight module, and may include a circuit board (not shown) for carrying and being electrically connected to the light emitting elements 108A and the light emitting elements 108B, and the circuit board may be disposed between the light emitting elements (for example, the light emitting elements 108A, the light emitting elements 108B) and the optical sensor 106. In this case, portions of the circuit board where no circuits are disposed on may allow the light L2 to penetrate through. For example, the circuits of the circuit board and the light emitting elements 108B may not overlap with each other in the direction VD perpendicular to the display surface is. In some embodiments, the light source 104 may further include an optical film 110 disposed between the liquid crystal panel 102 and the light emitting elements 108A, and/or disposed between the liquid crystal panel 102 and the light emitting elements 108B. The optical film 110 may be, for example, disposed between the liquid crystal panel 102 and the light emitting elements (the light emitting element 108A and the light emitting element 108B), for example, disposed on the surface 102B. For example, the optical film 110 may include a brightness enhancement film (BEF), a diffusion film, other suitable optical films, or a combination thereof. In some embodiments, the light source 104 may further include a reflective film (not shown) disposed under the light emitting elements 108A and the light emitting elements 108B to reflect the light L1 to improve utilization of the light L1 and allow the light L2 to pass through, such that the optical sensor 106 located under the light source 104 may detect the light L2.

In the embodiment shown in FIG. 1, the optical sensor 106 may be manufactured by a thin film process. For example, the optical sensor 106 may include a plurality of thin film transistors 112 capable of detecting light. In some embodiments, the thin film transistors 112 may be replaced with photodiodes or other photosensitive elements, and the photodiodes may include PIN diodes (phase shift switching diodes), for example. In the present disclosure, the thin film process may be defined as a process for manufacturing the thin film transistors or the photodiodes on a substrate, and the substrate may include a rigid substrate or a flexible substrate, wherein a material of the rigid substrate may for example include glass, ceramic, quartz sapphire, acrylic or other suitable materials, but is not limited thereto. A material of the flexible substrate may for example include polyimide (PI), polyethylene terephthalate (PET), polycarbonate (PC), polyether sulfone (PES), polybutylene terephthalate (PBT), polyethylene naphthalate (PEN) and polyarylate (PAR), other suitable materials or a combination thereof, but is not limited thereto. The thin film process may for example include a thin film deposition process and a photolithography and etching process, but is not limited thereto. In some embodiments, in the horizontal direction HD, the distribution width W3 of the optical sensor 106 may be defined as the distribution width of the thin film transistors 112, but is not limited thereto.

In an enlarged schematic view of a region R in FIG. 1, the thin film transistor 112 of a bottom-gate type is taken as an example. The optical sensor 106 may include a substrate 114, a gate electrode 116, a gate insulating layer 118, a semiconductor layer 120, a source electrode 122, a drain electrode 124, and a protective layer 126, wherein the gate electrode 116 may be disposed on the substrate 114, the gate insulating layer 118 may be disposed on the gate electrode 116, the semiconductor layer 120 may be disposed on the gate insulating layer 118, the source electrode 122 and the drain electrode 124 may be disposed on both ends of the semiconductor layer 120 and extend on the gate insulating layer 118, and the protective layer 126 may be disposed on the source electrode 122, the drain electrode 124 and the semiconductor layer 120. The gate electrode 116, the gate insulating layer 118, the semiconductor layer 120, the source electrode 122, and the drain electrode 124 may form the thin film transistor 112. The type of the thin film transistor 112 of the present disclosure is not limited to the bottom-gate type as shown in FIG. 1. In some embodiments, the thin film transistor 112 may include, for example, a top-gate type transistor, a dual-gate type/double-gate type transistor, or other suitable transistors. Alternatively, the thin film transistor 112 may also include, for example, an amorphous silicon transistor, a low-temperature poly-silicon (LTPS) transistor, an oxide semiconductor (metal-oxide semiconductor) transistor, or a combination thereof, and is not limited thereto. The oxide semiconductor may be for example indium gallium zinc oxide, but is not limited thereto.

In some embodiments, the display device 1 may further include a collimator 128 disposed between the light source 104 and the optical sensor 106 and may be for filtering out the light L2 with an incident angle greater than a specific angle and allowing the light L2 with an incident angle less than or equal to the specific angle to pass through, to improve image clarity detected by the optical sensor 106. For example, the incident angle may be, but not limited to, less than 5 degrees, 10 degrees, 20 degrees or 30 degrees. The incident angle may be for example an angle included between a propagation direction of the light L2 and a direction VD perpendicular to the display surface 1S. For example, the collimator 128 may include a light blocking layer 128L having a plurality of through holes 128h. In some embodiments, one of the through holes 128h may, for example, correspond to at least one of the thin film transistors 112, but is not limited thereto. In other embodiments, one of the through holes 128h may for example correspond to one of the light emitting elements 108B, but is not limited thereto. In some embodiments, the collimator 128 may for example include a plurality of lenses or other elements capable of collimating light.

In the embodiment of FIG. 1, the liquid crystal panel 102 may for example include a first polarizer 130, a first substrate 132, a thin film transistor layer 134, a liquid crystal layer 136, a color filter layer 138, a second substrate 140, and a second polarizer 142. The liquid crystal layer 136 may include liquid crystal molecules 136L and be disposed between the first substrate 132 and the second substrate 140. The first polarizer 130 may be disposed on a surface of the first substrate 132 opposite to the liquid crystal layer 136. The second polarizer 142 may be disposed on a surface of the second substrate 142 opposite to the liquid crystal layer 136. The thin film transistor layer 134 may be disposed on a surface of the first substrate 132 facing the liquid crystal layer 136. The color filter layer 138 may be disposed on a surface of the second substrate 142 facing the liquid crystal layer 136. In an embodiment, the thin film transistor layer 134 may be disposed between the liquid crystal layer 136 and the light source 104, but is not limited thereto. In some embodiments, the color filter layer 138 may include, for example, a red color filter layer R, a green color filter layer G, a blue color filter layer B, a light blocking layer (not shown, such as a black matrix layer), and other suitable elements, but not limited thereto. Those skilled in the art should know that the polarization direction of the first polarizer 130, the polarization direction of the second polarizer 142, the type of liquid crystal molecules 136L, the structure of the thin film transistor layer 134, and the structure of the color filter layer 138 may be adjusted according to the requirements and thus will not be detailed redundantly.

In some embodiments, the display device 1 may further include a protection plate 144 disposed on a surface of the liquid crystal panel 102 opposite to the light source 104 and for protecting the liquid crystal panel 102. The protection plate 144, the first substrate 132 and/or the second substrate 140 may include a rigid substrate or a flexible substrate, wherein a material of the rigid substrate may include, but is not limited to, glass, ceramic, quartz, sapphire, acrylic or other suitable materials. The flexible substrate may for example include PI, PET, PC, PES, PBT, PEN, PAR, other suitable materials or combinations of the mentioned above, but is not limited thereto.

It should be noted that the light source 104 is for generating the light L1 and the light L2 with different wavelengths or different wavelength ranges. One light L1 may be for displaying images, and the other light L2 may be for fingerprint identification. Therefore, the display device 1 may have both the fingerprint identification function and the display function. Through the distribution width W3 of the optical sensor 106, the fingerprint identification region of the display device 1 may be adjusted to a required size according to different requirements.

The display device of the present disclosure is not limited to the above embodiment and may have other embodiments or variant embodiments. In order to simplify the description, the other embodiments and variant embodiments mentioned in the following content will use the same reference numerals as those of the first embodiment to denote the same elements. For clearly describe other embodiments and variant embodiments, the following description may detail the dissimilarities among different embodiments, and the identical features will not be redundantly described.

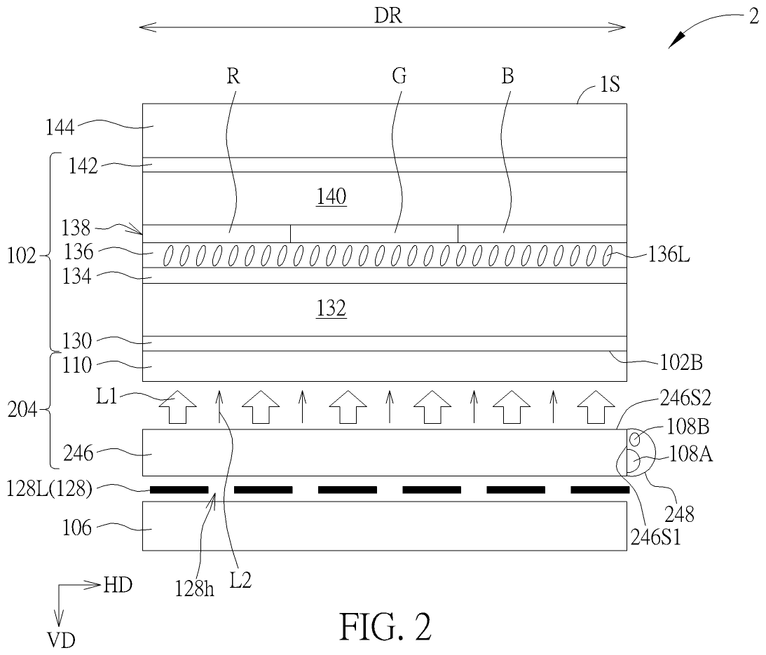

FIG. 2 schematically illustrates a cross-sectional view of a display device according to a second embodiment of the present disclosure. As shown in FIG. 2, the display device 2 in this embodiment may be different from the display device 1 shown in FIG. 1 in that the light source 204 may be an edge-type light source. In an embodiment, the light source 204 may include a light guide plate 246, and the light emitting element 108A and the light emitting element 108B may be disposed on a side surface 246S1 of the light guide plate 246, and the light L1 generated by the light emitting element 108A and the light L2 generated by the light emitting element 108B may enter the light guide plate 246 from the side surface 246S1 of the light guide plate 246. The light L1 and the light L2 may be scattered by the light guide plate 246 and then emitted out of the light guide plate 246 from a light exiting surface 246S2 of the light guide plate 246 adjacent to the side surface 246S1. In FIG. 2, the light emitting element 108A and the light emitting element 108B may be disposed on the same side surface 246S1 of the light guide plate 246, but not limited thereto. In some embodiments, the light emitting element 108A and the light emitting element 108B may be respectively disposed on different side surfaces of the light guide plate 246, such as adjacent side surfaces or opposite side surfaces.

In some embodiments, the light source 204 may further include a reflective frame 248 disposed on the side surface 246S1 of the light guide plate 246, and the light emitting element 108A and the light emitting element 108B may be disposed between the reflective frame 248 and the light guide plate 246, thereby improving the utilization of the light L1 and the light L2. In some embodiments, the light source 204 may further include a reflective film (not shown) disposed on a surface of the light guide plate 246 opposite to the light exiting surface 246S2 and for reflecting the light L1, to improve the utilization of the light L1. The reflective film may allow the light L2 to pass through, and the optical sensor 106 under the light guide plate 246 may detect the light L2.

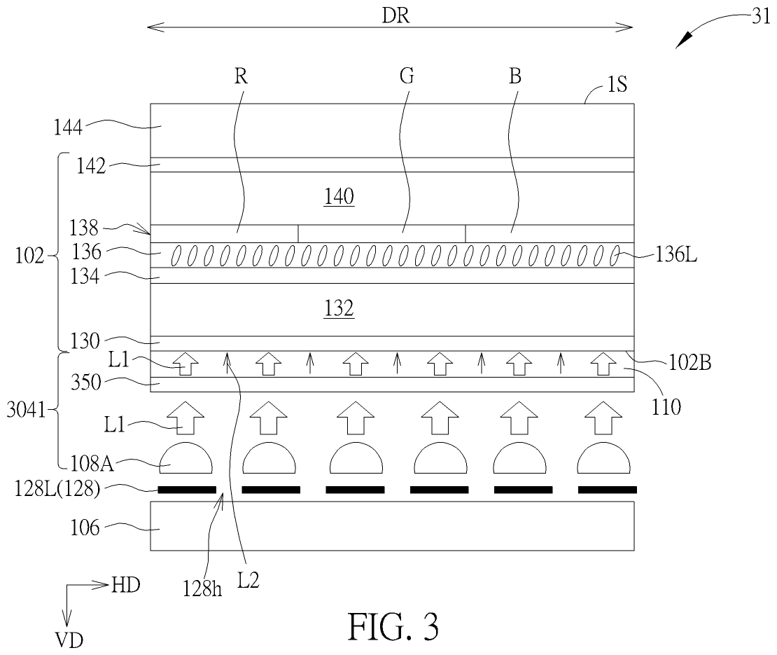

FIG. 3 schematically illustrates a cross-sectional view of a display device according to a third embodiment of the present disclosure. As shown in FIG. 3, the display device 31 provided in this embodiment may be different from the display device 1 shown in FIG. 1 in that the display device 3 may include a wavelength conversion layer 350 disposed on the light emitting elements 108A, and for converting a part of the light L1 generated by the light emitting elements 108A into another light L2. In the embodiment of FIG. 3, the wavelength conversion layer 350 may be disposed in the light source 3041 and disposed between the optical film 110 and the light emitting elements 108A. The wavelength conversion layer 350 may for example be disposed on a surface of the optical film 110 facing the light emitting elements 108A. The wavelength conversion layer 350 may emit the light L2 with a wavelength (or wavelength range) different from the wavelength (or wavelength range) of the light L1 by absorbing the light L1 and may allow another part of the light L1 to pass through without altering color of the light L1. For example, the wavelength conversion layer 350 may include quantum dots or other suitable wavelength conversion elements. In this case, the wavelength of the light L2 may be determined by the material and size of the quantum dots. For example, when the quantum dots are infrared light quantum dots, the light L2 may be infrared light. Since the light L2 may be generated by the wavelength conversion layer 350, the light source 3041 may not include the light emitting elements 108B shown in FIG. 1.

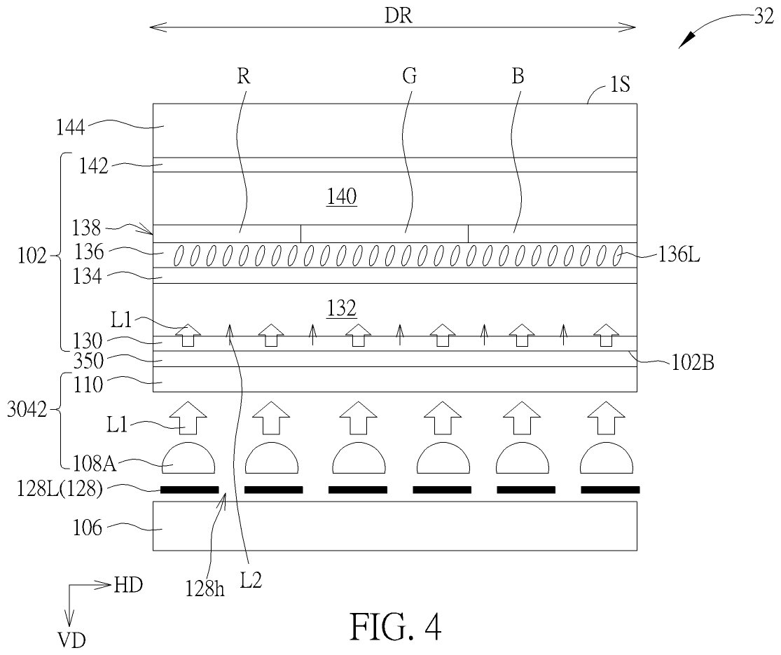

The position of the wavelength conversion layer 350 of the present disclosure is not limited to be disposed between the optical film 110 and the light emitting elements 108A as shown in FIG. 3. FIG. 4 schematically illustrates a cross-sectional view of a display device according to a variant embodiment of the third embodiment of the present disclosure. As shown in FIG. 4, the display device 32 provided in this variant embodiment may be different from the display device 31 shown in FIG. 3 in that the wavelength conversion layer 350 may be disposed between the optical film 110 and the first polarizer 130. In the variant embodiment of FIG. 4, the wavelength conversion layer 350 may be disposed outside the light source 3042 and on a surface of the first polarizer 130 opposite to the second polarizer 142, for example, disposed between the light source 3042 and the liquid crystal panel 102, but not limited thereto. For example, the wavelength conversion layer 350 may be disposed on a surface 102B of the liquid crystal panel 102, and the optical film 110 may be disposed on a surface of the wavelength conversion layer 350 opposite to the liquid crystal panel 102.

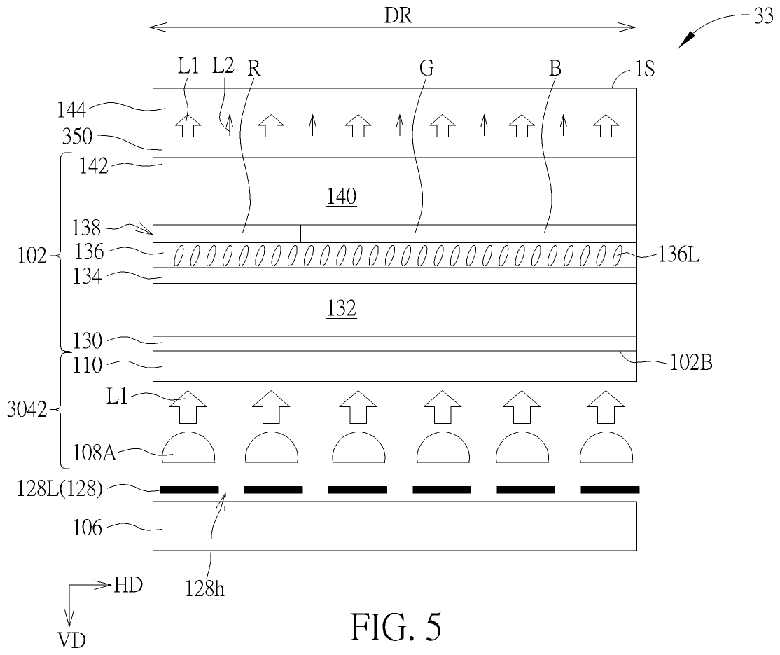

FIG. 5 schematically illustrates a cross-sectional view of a display device according to another variant embodiment of the third embodiment of the present disclosure. As shown in FIG. 5, the display device 33 provided in this variant embodiment may be different from the display device 32 shown in FIG. 4 in that the wavelength conversion layer 350 may be disposed on a surface of the second polarizer 142 opposite to the first polarizer 130. In the variant embodiment of FIG. 5, the liquid crystal panel 102 may be disposed between the light source 3042 and the wavelength conversion layer 350.

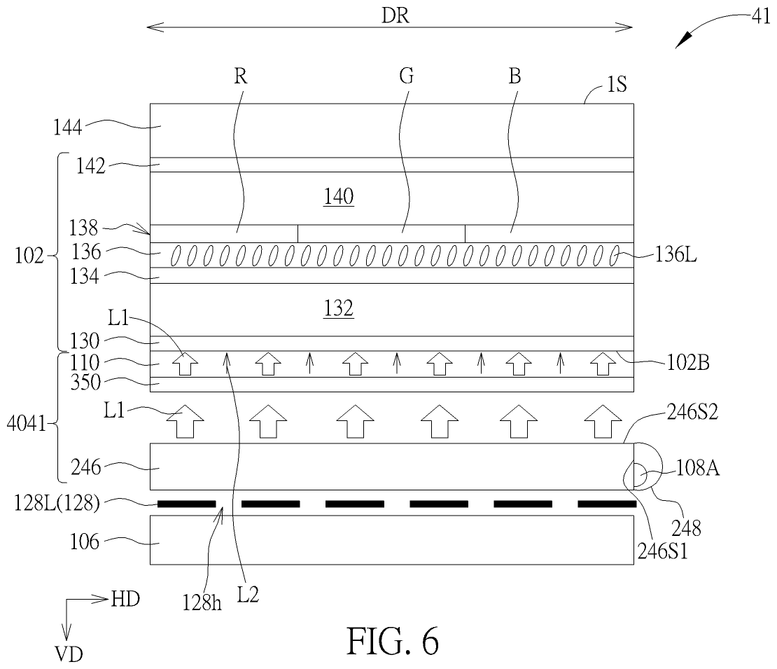

FIG. 6 schematically illustrates a cross-sectional view of a display device according to a fourth embodiment of the present disclosure. As shown in FIG. 6, the display device 41 provided in this embodiment may be different from the display device 31 shown in FIG. 3 in that the light source 4041 may be an edge-type light source. Similar to the light source 204 shown in FIG. 2, the light source 4041 may include the light guide plate 246, and the light emitting element 108A may be disposed on the side surface 246S1 of the light guide plate 246, and the light L1 generated by the light emitting element 108A may enter the light guide plate 246 from the side surface 246S1 of the light guide plate 246. The light L1 may be scattered by the light guide plate 246 and then emitted out of the light guide plate 246 from the light exiting surface 246S2 of the light guide plate 246 adjacent to the side surface 246S1. The light source 4041 is different from the light source 204 shown in FIG. 2 in that the light source 4041 may further include a wavelength conversion layer 350 disposed therein, for example, disposed between the light emitting element 108A and the optical film 110, and the light source 4041 may not include the light emitting element 108B. For example, the wavelength conversion layer 350 may be formed on the surface of the optical film 110 facing the light emitting element 108A and disposed between the light guide plate 246 and the optical film 110, but not limited thereto. In some embodiments, when the light source 4041 is an edge-type light source, the wavelength conversion layer 350 may be disposed outside the light source 4041 and between the light source 4041 and the liquid crystal panel 102.

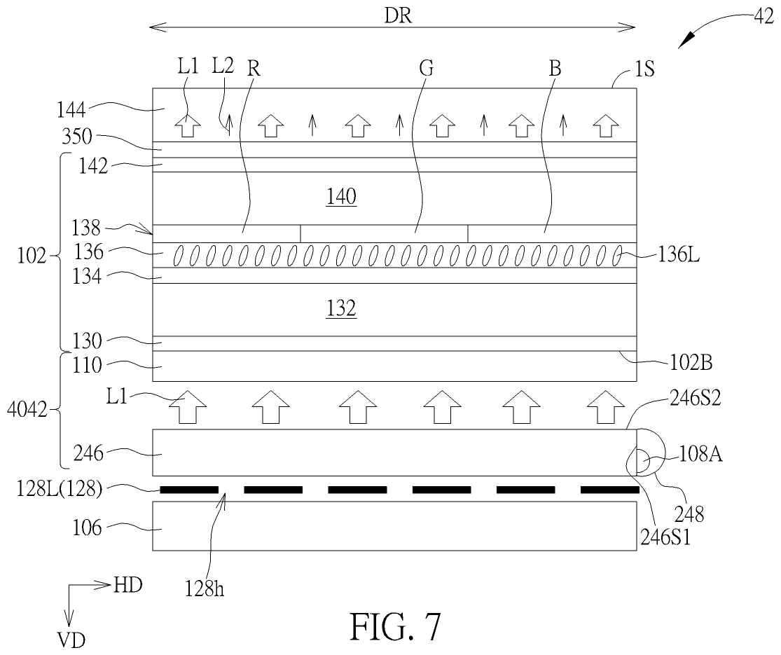

FIG. 7 schematically illustrates a cross-sectional view of a display device according to a variant embodiment of the fourth embodiment of the present disclosure. As shown in FIG. 7, the display device 42 provided in this embodiment may be different from the display device 41 shown in FIG. 6 in that the wavelength conversion layer 350 may be disposed on a surface of the second polarizer 142 opposite to the first polarizer 130. In the variant embodiment of FIG. 7, when the light source 4042 is the edge-type, the liquid crystal panel 102 may be disposed between the light source 4042 and the wavelength conversion layer 350.

In summary, in the display device of the present disclosure, by using different light emitting elements or the light emitting element in combination with the wavelength conversion layer, two lights with different wavelengths may be generated, such that one of the lights may be used as the backlight of the liquid crystal panel to make the display device display images, and the optical sensor disposed under the light source may detect another of the lights without affecting the images displayed by the display device, thereby achieving detection of fingerprint image. Therefore, the display device may have both the fingerprint identification function and the display function.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device, comprising:
a liquid crystal panel;
a light source comprising two light emitting elements emitting two lights with different wavelengths to the liquid crystal panel; and
an optical sensor, sensing one of the two lights;
wherein the light source is disposed between the liquid crystal panel and the optical sensor.

2. The display device of claim 1, wherein the one of the two lights has a wavelength greater than a wavelength of another one of the two lights.

3. The display device of claim 2, wherein the one of the two lights is an invisible light and the another one of the two lights is a visible light.

4. The display device of claim 3, wherein the invisible light is an infrared light.

5. The display device of claim 1, wherein the light source is an edge-type light source.

6. The display device of claim 1, wherein the light source is a direct-type light source.

7. The display device of claim 1, wherein the optical sensor is manufactured by a thin film process.

8. The display device of claim 1, further comprising a collimator disposed between the light source and the optical sensor.

9. The display device of claim 8, wherein the collimator comprises a light blocking layer having a plurality of through holes.

10. The display device of claim 9, wherein the optical sensor comprises a plurality of thin film transistors, and one of the through holes corresponds to at least one of the thin film transistors.

11. A display device, comprising:
a liquid crystal panel;
a light source comprising a light emitting element emitting a light to the liquid crystal panel;
a wavelength conversion layer disposed on the light emitting element, and the wavelength conversion layer converting a part of the light into another light, wherein a wavelength of the light is different from a wavelength of the another light; and
an optical sensor sensing one of the light and the another light;
wherein the light source is disposed between the liquid crystal panel and the optical sensor.

12. The display device of claim 11, wherein the wavelength of the another light is greater than the wavelength of the light.

13. The display device of claim 12, wherein the another light is an invisible light and the light is a visible light.

14. The display device of claim 13, wherein the invisible light is an infrared light.

15. The display device of claim 11, wherein the light source is an edge-type light source.

16. The display device of claim 11, wherein the light source is a direct-type light source.

17. The display device of claim 11, further comprising a collimator disposed between the light source and the optical sensor.

18. The display device of claim 11, wherein the light source further comprises an optical film, and the wavelength conversion layer is disposed between the light emitting element and the optical film.

19. The display device of claim 11, wherein the wavelength conversion layer is disposed between the light source and the liquid crystal panel.

20. The display device of claim 11, wherein the liquid crystal panel is disposed between the light source and the wavelength conversion layer.
